(19) United States
(12) Patent Application Publication
(10) Pub. No.: US 2017/0161272 A1
(43) Pub. Date: Jun. 8, 2017

(54) SOCIAL MEDIA SEARCH ASSIST

(71) Applicant: International Business Machines Corporation, Armonk, NY (US)

(72) Inventors: Masami Tada, Sagamihara (JP); Shoichiro Watanabe, Tokyo (JP)

(21) Appl. No.: 14/962,357

(22) Filed: Dec. 8, 2015

(51) Int. Cl. G06F 17/30

(52) U.S. Cl. CPC G06F 17/30029; G06F 17/30554

(57) ABSTRACT

A computer identifies social media displayed by a social media platform. The computer determines that a user has viewed the social media and saves the viewed social media in associated with the view date/time. The computer identifies and saves the interests associated with the user at the date/time the social media post was viewed by referencing the user profile and recent social media activity of both the user and associated users. The computer receives a social media query and cluster period from the user in regards to a previously viewed social media post. The computer displays the viewed social media that matches the search query as well as the interests associated with the user during each cluster period in which a matching social media post was viewed.

### TECHNICAL FIELD

The present invention relates generally to social media content, and more particularly to aiding in the identification of previously viewed social media content.

### BACKGROUND

Social media applications such as Facebook® (Facebook is a registered trademark of Facebook, Inc.), Twitter® (Twitter is a registered trademark of Twitter, Inc.), LinkedIn® (LinkedIn is a registered trademark of LinkedIn, Inc.) and Instagram® (Instagram is a registered trademark of Instagram, Inc.) have made sharing social media content between individuals increasingly popular and easy. In addition, smart phones and remote internet connectivity provide access to such social media applications at almost anytime, anywhere in the world. With much of the global population engaging in social media and many of those users sharing social media content on a daily basis, it is not uncommon for a user to view dozens, hundreds, or even thousands of shared social media posts on a daily basis. After viewing such a large volume of posts, it can be difficult, or even impossible, for a user to successfully reference a previously viewed social media post when trying to remember, for example, a recipe or custom workout routine previously viewed. While some social media applications allow a user to refer to previously viewed social media posts in which they are active, such as “liking” the post or “commented on” the post, there is still a need for a more inclusive aid to searching social media content that a user previously viewed.

### SUMMARY

Embodiments of the present invention disclose a method, system, and computer program product for identifying input interruption. A computer identifies social media displayed by a social media platform. The computer determines that a user has viewed the social media and saves the viewed social media in associated with the view date/time. The computer identifies and saves the interests associated with the user at the date/time the social media post was viewed by referencing the user profile and recent social media activity of both the user and associated users. The computer receives a social media query and cluster period from the user in regards to a previously viewed social media post. The computer displays the viewed social media that matches the search query as well as the interests associated with the user during each cluster period in which a matching social media post was viewed.

### BRIEF DESCRIPTION OF THE SEVERAL VIEWS OF THE DRAWING

FIG. 1 illustrates a social media search assist system, in accordance with an embodiment of the invention.

FIG. 2 is a flowchart illustrating the operations of a search assist program of FIG. 1 in aiding in the identification of previously viewed social media content.

FIG. 3 is a block diagram depicting the hardware components of the social media search assist system of FIG. 1, in accordance with an embodiment of the invention.

### DETAILED DESCRIPTION

Embodiments of the present invention will now be described in detail with reference to the accompanying figures.

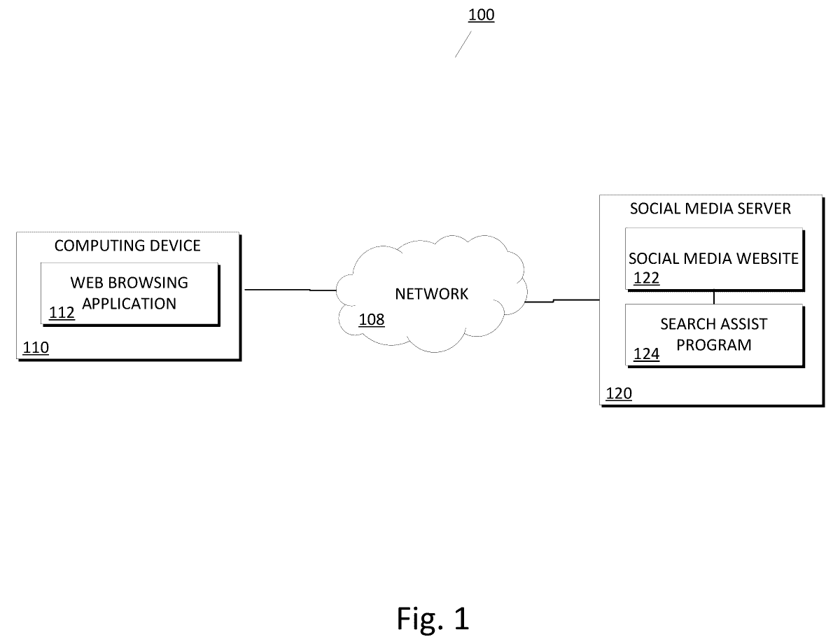

FIG. 1 illustrates a social media search assist system 100, in accordance with an embodiment of the invention. In the example embodiment, social media search assist system 100 includes network 108, computing device 110, and social media server 120.

In the example embodiment, network 108 may be the Internet, representing a worldwide collection of networks and gateways to support communications between devices connected to the Internet. Network 108 may include, for example, wired, wireless or fiber optic connections. In other embodiments, network 108 may be implemented as an intranet, a local area network (LAN), or a wide area network (WAN). In general, network 108 can be any combination of connections and protocols that will support communications between computing device 110 and social media server 120.

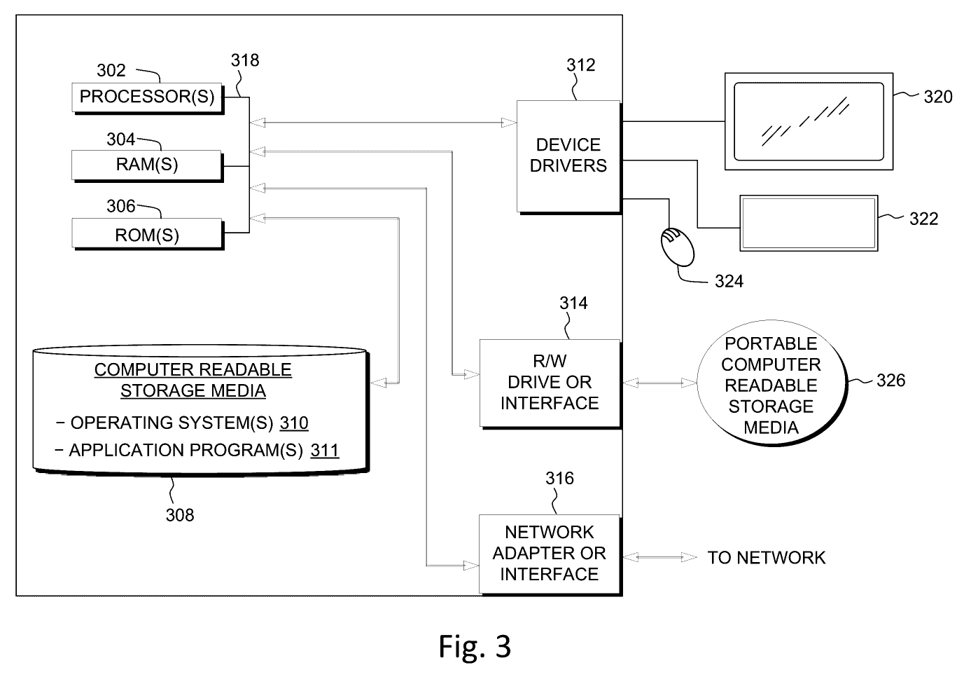

In the example embodiment, computing device 110 includes web browsing application 112. In the example embodiment, computing device 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While computing device 110 is shown as a single device, in other embodiments, computing device 110 may be comprised of a cluster or plurality of computing devices, working together or working separately. Computing device 110 is described in more detail with reference to FIG. 3.

In the example embodiment, web browsing application 112 is a program, such as a web browser, on computing device 110 capable of retrieving, presenting, and transmitting information to other computing devices connected to the world wide web.

In the example embodiment, social media server 120 includes social media website 122 and search assist program 124. In the example embodiment, social media server 120 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While social media server 120 is shown as a single device, in other embodiments, social media server 120 may be comprised of a cluster or plurality of computing devices, working together or working separately. Social media server 120 is described in more detail with reference to FIG. 3.

In the example embodiment, social media website 122 is a website capable of hosting social media content shared between registered users, including user profiles and social media posts. In the example embodiment, social media website 122 is accessed via an internet browser, such as web browsing application 112 on computing device 110. In other embodiments, however, social media website 122 may be accessed via other means or social media website 122 may be a standalone program.

Search assist program 124 is a program on social media server 120 which is integrated with social media website 122 and capable of detecting when a user views social media posts on a social media website, such as social media website 122, and saving the viewed social media posts. Search assist program 124 is additionally capable of referencing the profiles and recent activity of the viewer (user), publisher of the social media posts, and/or followers/followees of the viewer/publisher to obtain interest information of the user at the time the social media post was viewed. Search assist program 124 is further capable of recording the referenced interest information and associating it with the date. Search assist program 124 is further capable of receiving a social media search query and cluster period from a user and searching the saved, viewed social media posts of the user for the search terms. If the search results in a match, search assist program 124 is additionally capable of clustering the interests of the user during the cluster period and displaying both the matching social media posts and associated interest information to the user along a timeline.

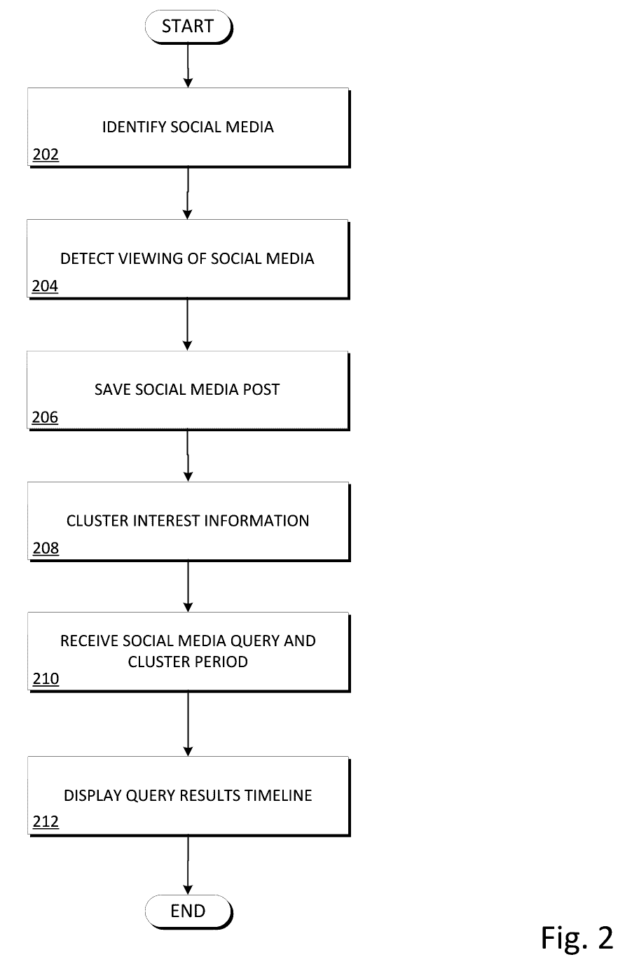

FIG. 2 is a flowchart depicting the operation of search assist program 124 in assisting in the search of previously viewed social media by recording the interest information of the viewer at the time the social media post is viewed. In the example embodiment, a user registers an account with social media website 122 and creates a customized user profile page detailing information about them self, such as the name, interests, and a picture of the user. In addition, registered users may also create associations with other users by establishing relationships with them, including relationships such as “friend”, “connection”, “family”, and “follower/followee”. Each of the registered users may publish original content (“post”) or share content published by others (“repost”) which may include text, images, videos, audio, files, and hyperlinks. In the example embodiment, a user may share (post or repost) content to specific users based on the relationships enumerated above and other registered users may view, comment on, like, dislike, or otherwise express an opinion about the shared post. In the example embodiment, social media website 122 includes a recent activity page which displays recent activity, whether it be posts, reposts, commented posts, liked posts, etc., of other users with which the user has one of the aforementioned relationships, such as “friends”. Furthermore, the recent activity page may be toggled to display the recent activity of all members of the social media platform or topics which are trending in social media.

Search assist program 124 identifies social media (step 202). Before determining whether social media post is viewed by the user of computing device 110, search assist program 124 must first identify social media posts within social media website 122. In the example embodiment, social media posts include information shared by registered users with others, such as status updates and the sharing of text, hyperlinks, media, and user locations. In the example embodiment where search assist program 124 is integrated with social media website 122, search assist program 124 identifies social media posts by communicating with social media website 122. In the example embodiment, social media website 122 receives the activity of users, such as a user logging in and navigating through the different webpages/user profiles associated with social media website 122, as well as the actions of the user, such as “liking” and commenting on social media posts. Other user inputs/activity may include replies, shares, and viewing of audio/video media shared in the post via button clicks. In the example embodiment, search assist program 124 communicates with social media website 122, or the application program interface (API) thereof, to identify the user actions received by social media website 122 as well as the social media posts receiving said user actions. In the example embodiment, search assist program 124 identifies social media posts by communicating with social media website 122 to identify the entities the user applies a user input, such as a “like” or comment made to a social media post. For example, if a user logs into a social media website and “likes” a post by a friend, then search assist program 124 communicates with social media website 122 to determine that the post by the friend is a social media post.

In addition to identifying social media content through communicating with social media website 122, search assist program 124 also identifies social media content by monitoring web browsing application 122 (step 202 cont'd). In the example embodiment, search assist program 124 monitors web browsing application 122 for the retrieval of information from an internet protocol address (IP), or web address, associated with social media website 122 and/or social media server 120. For example, if web browsing application 112 retrieves information from an IP address associated with social media, then search assist program 124 begins identifying social media posts. In the example embodiment, search assist program 124 is configured by the user to search for specific IP addresses associated with social media website 122, however in other embodiments, search assist program 124 may determine which IP addresses are associated with social media by other means. Search assist program 124 is additionally capable of searching the hypertext markup language (HTML) of social media website 122 for specific pages of the website and sections of said pages associated with social media posts. For example, if the bulk of social media posts on social media website 122 is displayed in the body of a page known as the “news feed”, then search assist program 124 searches the body of the “news feed” page to identify social media posts. Similarly, a user configures search assist program 124 to know which webpages and sections of webpages to look for social media posts depending on the social media platform or, in other embodiments, search assist program 124 may be configured to search for large collections of tags and metadata associated with social media posts, such as usernames of friends, symbols such as hashtags, “like” buttons, comment/reply fields, post times, reposts/shares, and other information indicative of social media posts, and then associate the page/section with social media posts (note that determining pages/sections associated with social media posts may also be determined through communication with social media website 122 described above). Search assist program 124 is additionally capable of utilizing natural language processing and character recognition techniques to search the HTML for the aforementioned tags and metadata commonly associated with specific portions of social media posts. In the example embodiment, a user may either configure search assist program 124 to recognize specific tags/metadata or configure search assist program 124 to reference specific databases for the tags/metadata to associate with social media posts. For example, search assist program 124 may search a friends or followers database to determine whether information associated with a potential username is a social media post published by the potential user. Similarly, search assist program 124 may search trending hashtags to determine whether a word next to a hashtag is an indication of a social media post.

Having identified the social media post(s) within a page, search assist program 124 detects whether the social media post has been viewed by the user (step 204). In the example embodiment, search assist program 124 determines whether the post has been viewed by communicating with social media website 122 to determine whether the shared post has received user input, such as being selected, commented on, (dis)liked, shared, or otherwise acted on by the user. In cases where a user views but does not apply a user input to the social media post, search assist program 124 determines whether social media post has been viewed by other means, such as determining a view time of each social media post. In the example embodiment, search assist program 124 communicates with web browsing application 112 to determine the viewing time of each identified social media post. The viewing time is the amount time the user spent with the social media post on the screen before scrolling or navigating elsewhere. In order to determine the viewing time of a particular social media post, search assist program 124 communicates with the operating system of computing device 110 to determine the coordinate positions of the social media post and the coordinate positions within view of the computing device screen. If the top left and bottom right coordinates of the social media post (or, for example, the majority of the area of the social media post) stay within the viewable coordinates of the computing device screen for a threshold time or longer, such as ten seconds, then the social media post is considered viewed. In an example where the user is scrolling through the “news feed” of social media website 122 described above, if the user clicks the “like” button of a post by her soccer teammate, Player, about a great lunch place in Tokyo, then the social media post about the great lunch place in Tokyo is considered viewed. Similarly, if the user hadn't clicked “like” button of the post, however the coordinates of the social media post stay within the viewable screen of computing device 110 for fifteen seconds, then the social media post is considered viewed because the social media post was within the viewable screen area of computing device 110 for more than ten seconds. Note that the viewable screen may differ for different computing devices. In the example embodiment, search assist program 124 determines the threshold viewing time based on statistics such as the average viewing time of an average user, the average reading speed of an average user, the number of words in the particular social media post, or a combination thereof. Similarly, the threshold viewing time may be tiered such that longer viewing times are indicative of a stronger interest in the social media post and weighed accordingly. For example, viewing a post for ten or more seconds indicates a stronger interest in the topic than viewing the post for between three and six seconds.

Once search assist program 124 determines that a social media post has been viewed, search assist program 124 saves the content of the social media post and associates it with the view date for future reference (step 206). In the example embodiment, search assist program 124 stores a screenshot of the social media post, however in other embodiments, search assist program 124 may save the content of the post by other means, such as saving an HTML or a text file associated with the post. The method of saving the viewed social media post may vary based on the amount of social media viewed by the user and storage space allocated for viewed social media posts. Search assist program 124 may be configured to delete saved social media posts after a threshold duration. In addition to saving the social media content, search assist program 124 additionally categorizes the post by utilizing natural language processing and character recognition techniques to search the content of and tags associated with the post for indications of the relevant subject matter. In the example embodiment, search assist program 124 compares the words/tags of the social media post with a user-configured database of words and associated categories to determine how to categorize the social media post. Furthermore, in other embodiments, search assist program 124 may be configured to store unrecognizable words, or words not listed in the database, which commonly appear in viewed social media posts/profiles to expand the recognizable database of words to include slang, abbreviations, and other unrecognizable verbiage. Using the example above, if the social media post about lunch in Tokyo contains the word sushi and sushi is associated with food and drink, then search assist program 124 categorizes the post as a post involving food and drink. In the example embodiment, multiple categories may be associated with social media posts. As such, if the name of the sushi restaurant in the example above is mentioned/tagged in the post and the restaurant is also associated with nightclubs, then the post is categorized as both food and drink and nightclubs.

Search assist program 124 clusters interest information corresponding to the user within a cluster period of the time/date that the social media post was viewed (step 208). Clustering interest information involves data mining large amounts of user information and recording interests most commonly associated with the user over a cluster period (recurring intervals of time). Establishing the prominent interests of a user at the time a social media post is viewed helps provide the user with a point of reference in time when attempting to recall previously viewed social media posts. In the example embodiment, each time search assist program 124 detects the viewing of social media posts in step 204, search assist program 124 communicates with social media website 122 to record and cluster the interests of the user based on both the social media profile and recent social media activity of the user. In the example embodiment, search assist program 124 utilizes natural language processing and character recognition techniques to identify interest information of the user, however in other embodiments, other language recognition techniques may be used. Search assist program 124 first searches the profile of the user for listed interests. In the example embodiment, the user profile includes information detailing the user, such as the name, birthday, sex, location, occupation, significant other(s), and hobbies of the user. Other interests detailed by the profile page may further include favorites of the user, such as favorite foods, drinks, locations, books, movies, TV shows, music, sports, athletes, celebrities, and sports teams. Continuing the example above, if the user viewed the social media post by Player at 11:11 PM on 11/11/15 and the interests detailed by the user profile of the user at that time include soccer, do it yourself (DIY), and knitting, then search assist program 124 records the user interests of soccer, do it yourself, and knitting and associates those interests with 11:11 PM on 11/11/15.

In addition to referencing the user profile for interests of the user, search assist program 124 additionally utilizes natural language processing and character recognition techniques (as well as the categorization of the post determined in step 206) to record interests of the user found in recent social media activity (step 208 cont'd). Continuing the example, if the user “liked” the social media post about Tokyo lunch at 11:12 PM on 11/11/15 regarding sushi, then search assist program 124 records the interests of sushi, lunch, Tokyo and the category food and drink at 11:12 PM on 11/11/15. In the example embodiment, activity is limited to specific actions, such as “like” and comment/share/reply actions, and does not include simply viewing a post. However, in other embodiments, search assist program 124 may be configured to record interests from user profiles and recent social media activity otherwise, such as collecting interests from all posts determined viewed. Therefore, in the example, interests of the user between 11:11 PM and 11:12 PM on 11/11/15 (a cluster period of one minute) include soccer, do it yourself, knitting, sushi, lunch, and Tokyo. The recorded interests of the user are then clustered into rankings. In the example embodiment, search assist program 124 takes into consideration not only the amount of times (occurrence count) an interest is detected within the profile or recent activity of the user, but may be configured to add extra weight to the interest level based on a variety of factors, such as whether the interest is mentioned by the user himself or an associated user, in the user profile or a post, what section of user profile the interest is detailed, post popularity, the relationship between the user and the publisher, whether the user “liked/shared/commented/replied” to the post, whether the social media post is categorically similar to a profile interest/recent activity of the user, and the view time. In order to determine whether the content of the social media post is categorically similar to an interest of the user, search assist program 114 utilizes a database of words and associated categories to determine a category for the social media post and a category for the interests of the user. Search assist program 114 then determines whether the category of the interests of the user are the same or similar to the category of the content within the social media post. Alternatively, search assist program 114 may also compare the interests of the user verbatim to the content of the social media post in order to determine whether the interests of the user are present within the social media post. Continuing the example above, if interests listed in the profile are weighed more heavily than interests found in recent activity, then search assist program 124 would weight soccer, DIY, and knitting more heavily than sushi, lunch, and Tokyo.

In the example embodiment, search assist program 124 additionally records and clusters the interests of other users with whom the user has a relationship/association, such as the friends, family, followers/followees, and connections of the user (step 208 cont'd). Search assist program 124 imputes the interests of selected, associated users with the user because it is likely that closely associated users share like interests with the user. In addition, it is also possible that although the user may not publish a particular interest at the time, that interest recorded by associated users may nonetheless serve as a memory aid for the user. Similar to recording the interests of the user, recording the interests of associated users involves utilizing natural language processing and character recognition techniques to data mine the user profiles and social media activity of the associated users. In the example embodiment, interests of associated users may be imputed to the interests of the user when the interests of an associated user match the interests of the user. Determining whether the interests match is based on both using character matching techniques to compare the interests verbatim as well as referencing directories of synonyms to link closely related interests. Using the example above with the social media post about Tokyo lunch by Player, if at the time the user viewed the Tokyo sushi lunch post and the interests listed in the user profile of Player include soccer, football, and cooking, then search assist program 124 records an additional user interest in soccer because both the user and Player, an associated user, have a like interest in soccer. Similarly, search assist program 124 may be configured to apply different weights to interests based on where they are found (for example, associated user profile vs. associated user post, etc.). In other embodiments, search assist program 124 may impute the dislike interests of associated users as well. Using the example above, if dislike interests of associated users (compared to the user) are imputed to the interests of the user, then football and cooking would also be recorded as interests of the user. Based on configuring search assist program 124 for which interests to record, the weight to apply to each interest, and the cluster period selected, search assist program 124 is capable of clustering the greatest interests of a user (and associated users) for a specific cluster period.

Furthermore, in the example embodiment, search assist program 124 may be configured to cluster the interests of the user and associated users periodically rather than (or in addition to) clustering the interests upon the detection of viewed social media posts in step 204 (step 208 cont'd). In such embodiments, search assist program 124 may be configured to reference and cluster the interests of the user periodically, such as on a daily or weekly basis, and/or upon detecting changes to the profile of the user/associated users. Similarly, in such embodiments, search assist program 124 records and weighs the interest as well the time/date in order to cluster interests over a cluster period at a later date.

Search assist program 124 receives a social media query and cluster period from the user (step 210). In the example embodiment, the cluster period defines the duration of time during which the interests of a user are clustered. In the example embodiment, the cluster period is user defined based on the desired granularity of the search results, however the default cluster period is one month. Furthermore, the search query is compared against both the categorization of the social media post as well as any identified words within the social media post. Continuing the social media example above where Player posted about a sushi lunch in Tokyo, if the user searches the previously viewed social media posts for “food and drink”, then search assist program 124 searches the categorizations and content contained in all previously viewed social media posts to find the social media post about sushi lunch in Tokyo. Similarly, if the user searches “sushi”, “lunch”, or “Tokyo”, then search assist program 124 searches the categorizations and content of all previously viewed posts to find the social media post about lunch in Tokyo. After identifying all of the previously viewed social media posts which match the search query, search assist program 124 clusters the interests of the user within the defined cluster periods surrounding a matching, viewed social media post. In the example embodiment where the cluster period is one month, search assist program 124 clusters information for the month during which the social media post was viewed. In the example above, if the social media post was viewed on 11/11/15, then search assist program 124 clusters the interest of the user for the entire month of November. In other embodiments, however, the cluster period may begin on the date the post was viewed (for example: cluster period from 11/11/15 to 12/11/15) or may be split around the date of the post view (for example: 9/26/15 to 11/26/15).

Search assist program 124 displays the query results along a timeline (step 212). In the example embodiment, the timeline is broken down into individual cluster periods such that the user can browse the dominant interests associated with each cluster period in chronological or descending order. The greatest interests during the cluster period are emphasized by means such as listing the interests in descending order, plotting the interests on a chart of interest v. viewed contents, or varying the size of a figure representing the interest (such as a bubble) relative to figures representative of the other interests. Continuing the example above where the user viewed the social media post by Player about Tokyo lunch in November while the user was most interested in soccer, do it yourself, and knitting, if the user searches for previously viewed posts about “lunch” after also viewing a December post by Coworker about a cobb salad lunch while the prominent interests of the user were skiing, winter Olympics, and hockey, then search assist program 124 displays one cluster period corresponding to November listing the interests soccer, do it yourself, and knitting as well as a second cluster period corresponding to December listing the interests skiing, winter Olympics, and hockey. Furthermore, if the user exhibited the greatest interest in soccer during the cluster period of November, then soccer is emphasized by listing soccer at the top of a descending list of interests. In the example embodiment, each cluster period is selectable and, upon user selection, displays all of the previously viewed social media from that cluster period which match the received search query. Continuing the example above, if the user searches previously viewed social media posts for “lunch” and selects the cluster period corresponding to November, then search assist program 124 displays the social media post by Player regarding sushi lunch in Tokyo. Furthermore, in the example embodiment, each interest cluster within the selected cluster period is additionally selectable and, upon user selection, displays all of the viewed social media posts which are both associated with the interest and match the search query (when applicable). How search assist program 124 determines an association between an interest and social media post may be configured by a user but, for example, may include associating social media posts by users who share like profile interests with the user with said, like profile interests. Continuing the example above where the user has selected the cluster period corresponding to November and the profiles of both user and Player listed soccer as an interest during November, if the user clicks the clustered soccer interest, then search assist program 124 displays the sushi lunch in Tokyo social media post by Player because Player is associated with an interest in soccer and the social media post regarding sushi lunch by Player matches the search query “lunch”. Similarly, a social media post may be associated with an interest of the user if the social media post is characterized like an interest of the user. For example, if Player posts about soccer and soccer is listed in the profile of the user, selecting the soccer interest in the November cluster period will display the soccer post by Player.

FIG. 3 depicts a block diagram of components of computing device 110 of social media search assist system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, for example, search assist program 124, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 314 to read from and write to one or more portable computer readable storage media 326. Application programs 311 on computing device 110 may be stored on one or more of the portable computer readable storage media 326, read via the respective R/W drive or interface 314 and loaded into the respective computer readable storage media 308.

Computing device 110 may also include a network adapter or interface 316, such as a TCP/IP adapter card or wireless communication adapter (such as a 4G wireless communication adapter using OFDMA technology). Application programs 311 on computing device 110 may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Computing device 110 may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for searching viewed social media, the method comprising:
determining whether content displayed to a user by a social media platform is a social media post by referencing a list of usernames associated with one or more friends of the user and searching markup language associated with the content for the one or more usernames on the list;
based on determining that the content is a social media post, determining whether the user has viewed the social media post by determining whether a viewing time exceeds a threshold period of time, wherein the viewing time is an amount of time that one or more coordinates positions corresponding to the social media post are encompassed by one or more coordinate positions defining a viewable screen area of a device corresponding to the user;
based on determining that the user has viewed the social media post, storing the viewed social media post in association with the user and a time period at which the social media post was viewed by the user;
based on determining that the user has viewed the social media post, identifying one or more interests corresponding to the user at the time period, wherein the one or more interests corresponding to the user are based on a user profile corresponding to the user, recent activity corresponding to the user, a user profile corresponding to the one or more friends of the user, and recent activity corresponding to the one or more friends of the user;
weighing and ranking the one or more interests corresponding to the user based on an amount of instances and a location where an interest is identified, wherein a larger amount of instances carries greater weight than a lesser amount of instances, and wherein interests located within the user profile of the user are weighed more than interests located in the recent activity of the user, and wherein interests located within a user profile and recent activity of the one or more friends of the user are weighed less than that of an interest located in the recent activity of the user;
receiving one or more search terms and a duration of time from the user;
determining that the social media post corresponds to the one or more search terms; and
displaying the social media post and displaying the weighed and ranked one or more interests corresponding to the duration of time based on determining that at least a portion of the time period is within the duration of time,
wherein one or more steps of the above method are performed using one or more computers.

2. The method of claim 1, wherein weighing and ranking the one or more interests corresponding to the user is further based on identifying one or more disliked interests corresponding to the user at the time period and one or more disliked interests corresponding to the one or more friends of the user at the time period.

3. The method of claim 1, wherein identifying one or more interests corresponding to the user is further based on an end of a predefined and periodically repeated interval of time.

4. The method of claim 1, further comprising:
determining one or more categories associated with at least one of the one or more interests corresponding to the user by comparing each of the one or more interests corresponding to the user with a database of words and associated categories;
determining one or more categories associated with the social media post by comparing one or more terms contained in the social media post with the database of words and associated categories;
determining that at least one of the one or more categories associated with the at least one of the one or more interests corresponding to the user matches at least one of the one or more categories associated with the social media post; and
associating the social media post with the at least one of the one or more interests corresponding to the user.

5. The method of claim 4, wherein the step of displaying the social media post and displaying at least one of the one or more interests is further based on determining that at least one of the one or more categories associated with at least one of the one or more interests corresponding to the user matches at least one of the one or more categories associated with the social media post.

6. (canceled)

7. The method of claim 4, wherein weighing and ranking the one or more interests corresponding to the user is further based on the determined one or more categories associated with the social media post and the determined viewing time, and wherein the viewing time is tiered such that a greater duration viewing time carries more weight than a lesser duration viewing time.

8. A computer program product for searching viewed social media, the computer program product comprising:
one or more computer-readable storage media and program instructions stored on the one or more computer-readable storage media, the program instructions comprising:
program instructions to receive a query regarding previously viewed social media from a user;
program instructions to receive a cluster period from the user, wherein the cluster period defines a period of time in which to cluster one or more interests corresponding to the user;
program instructions to determine whether the query corresponds to at least one previously viewed social media;
based on determining that the query corresponds to at least one previously viewed social media, program instructions to cluster the one or more interests corresponding to the user which are within the cluster period of each of the at least one previously viewed social media; and
program instructions to display the at least one previously viewed social media in association with the one or more interests corresponding to the user which are within the cluster period of the at least one previously viewed social media.

9. The computer program product of claim 8, wherein the one or more interests corresponding to the user are based on a social media profile corresponding to the user, recent social media activity of the user, and one or more interests corresponding to one or more users associated with the user, wherein the one or more interests corresponding to the one or more users associated with the user are based at least one of: (i) one or more user profiles corresponding to the one or more users associated with the user and (ii) recent activity corresponding to the one or more users associated with the user.

10. The computer program product of claim 9, further comprising:
program instructions to apply a weight factor to each of the one or more interests corresponding to the user based on an amount of instances and a location where an interest is identified, wherein a larger amount of instances carries greater weight than a lesser amount of instances, and wherein interests located within the profile of the user are weighed more than interests located in the recent activity of the user, and wherein interests located within a user profile and recent activity of the one or more users associated with the user are weighed less than that of an interest located in the recent activity of the user; and
program instructions to rank the one or more interests corresponding to the user based on the applied weight factors.

11. The computer program product of claim 10, wherein the program instructions to display the at least one previously viewed social media in association with the one or more interests corresponding to the user which are within the cluster period of the at least one previously viewed social media further comprises:
program instructions to display the one or more interests corresponding to the user in descending order based on the ranking.

12. The computer program product of claim 10, wherein the program instructions to display the at least one previously viewed social media in association with the one or more interests corresponding to the user which are within the cluster period of the at least one previously viewed social media further comprises:
program instructions to display the one or more interests corresponding to the user within one or more bubbles surrounding the at least one previously viewed social media, wherein a size of the one or more bubbles corresponds to the ranking of the one or more interests corresponding to the user.

13. (canceled)

14. The computer program product of claim 10, wherein the program instructions to display the at least one previously viewed social media in association with the one or more interests corresponding to the user which are within the cluster period of the at least one previously viewed social media further comprises:
program instructions to display the at least one previously viewed social media and corresponding one or more interests along a timeline, wherein the one or more interests corresponding to the user are displayed within one or more bubbles surrounding the at least one previously viewed social media, and wherein a size of the one or more bubbles corresponds to the ranking of the one or more interests corresponding to the user.

15. A computer system for searching viewed social media, the computer system comprising:
one or more computer processors, one or more computer-readable storage media, and program instructions stored on one or more of the computer-readable storage media for execution by at least one of the one or more processors, the program instructions comprising:
program instructions to determine whether content displayed to a user by a social media platform is a social media post by referencing a list of usernames associated with one or more friends of the user and searching markup language associated with the content for the one or more usernames on the list;
based on determining that the content is a social media post, program instructions to determine whether the user has viewed the social media post by determining whether a viewing time exceeds a threshold period of time, wherein the viewing time is an amount of time that one or more coordinates positions corresponding to the social media post are encompassed by one or more coordinate positions defining a viewable screen area of a device corresponding to the user;
based on determining that the user has viewed the social media post, program instructions to store the viewed social media post in association with the user and a time period at which the social media post was viewed by the user;
based on determining that the user has viewed the social media post, program instructions to identify one or more interests corresponding to the user at the time period, wherein the one or more interests corresponding to the user are based on a user profile corresponding to the user, recent activity corresponding to the user, a user profile corresponding to the one or more friends of the user, and recent activity corresponding to the one or more friends of the user;
program instructions to weigh and rank the one or more interests corresponding to the user based on an amount of instances and a location where an interest is identified, wherein a larger amount of instances carries greater weight than a lesser amount of instances, and wherein interests located within the user profile of the user are weighed more than interests located in the recent activity of the user, and wherein interests located within a user profile and recent activity of the one or more friends of the user are weighed less than that of an interest located in the recent activity of the user;
program instructions to receive one or more search terms and a duration of time from the user;
program instructions to determine that the social media post corresponds to the one or more search terms; and
program instructions to display the social media post and displaying the weighed and ranked one or more interests corresponding to the duration of time based on determining that at least a portion of the time period is within the duration of time.

16. The computer system of claim 15, wherein weighing and ranking the one or more interests corresponding to the user is further based on:
program instructions to identify one or more disliked interests corresponding to the user at the time period and one or more disliked interests corresponding to the one or more friends of the user at the time period.

17. The computer system of claim 15, wherein identifying one or more interests corresponding to the user is further based on an end of a predefined and periodically repeated interval of time.

18. The computer system of claim 15, further comprising:
program instructions to determine one or more categories associated with at least one of the one or more interests corresponding to the user by comparing each of the one or more interests corresponding to the user with a database of words and associated categories;
program instructions to determine one or more categories associated with the social media post by comparing one or more terms contained in the social media post with the database of words and associated categories;
program instructions to determine that at least one of the one or more categories associated with the at least one of the one or more interests corresponding to the user matches at least one of the one or more categories associated with the social media post; and
program instructions to associate the social media post with the at least one of the one or more interests corresponding to the user.

19. The computer system of claim 18, wherein the program instructions to display the social media post and the program instructions to display at least one of the one or more interests is further based on determining that at least one of the one or more categories associated with at least one of the one or more interests corresponding to the user matches at least one of the one or more categories associated with the social media post.

20. The computer system of claim 15, wherein weighing and ranking the one or more interests corresponding to the user is further based on the determined one or more categories associated with the social media post and the determined viewing time, and wherein the viewing time is tiered such that a greater duration viewing time carries more weight than a lesser duration viewing time.
